(19) United States
(12) Patent Application Publication
(10) Pub. No.: US 2014/0032942 A1
(43) Pub. Date: Jan. 30, 2014

(54) VOLTAGE REGULATOR, SEMICONDUCTOR DEVICE, AND DATA PROCESSING SYSTEM

(71) Applicant: RENESAS ELECTRONICS CORPORATION, Kanagawa (JP)

(72) Inventors: Yuji TAKEHARA, Kanagawa (JP); Koji SAIKUSA, Kanagawa (JP); Ryotaro KUDO, Itami (JP); Toshio NAGASAWA, Itami (JP)

(73) Assignee: RENESAS ELECTRONICS CORPORATION, Kanagawa (JP)

(21) Appl. No.: 13/953,306

(22) Filed: Jul. 29, 2013

(30) Foreign Application Priority Data
Jul. 30, 2012 (JP) 2012-168235

(51) Int. Cl. H02M 3/156; G06F 1/26

(52) U.S. Cl. CPC H02M 3/156; G06F 1/26
USPC 713/300; 323/282

(57) ABSTRACT

A voltage regulator has a voltage converter circuit and a control unit. The control unit controls the voltage converter circuit so that an output voltage attains a target voltage when the voltage regulator is in a no-load condition so as to have a transition characteristic in which the output voltage decreases with increase in the load current. The control unit calculates deviation between the output voltage and an ideal value thereof when a load condition of the voltage regulator is a first load condition, and corrects the target voltage by the output voltage adjustment unit. so The control unit also calculates deviation between rate of change of the output voltage with respect to the load current and an ideal value thereof, and corrects the transition characteristic so that the deviation becomes small to minimize deviation.

### CROSS-REFERENCE TO RELATED APPLICATIONS

The disclosure of Japanese Patent Application No. 2012-168235 filed on Jul. 30, 2012 including the specification, drawings and abstract is incorporated herein by reference in its entirety.

### BACKGROUND

The present invention relates to a voltage regulator for generating a power supply voltage, a data processing system including the voltage regulator, and a semiconductor device for controlling the voltage regulator, and particularly to a technique effectively applied to a voltage regulator that varies a power supply voltage in accordance with a load current.

There has been known a switching regulator as a voltage regulator (hereinafter also referred to as VR) for supplying a large current. The switching regulator is comprised of, for example, a voltage converter circuit for converting an input voltage and outputting the converted voltage and a VR controller for controlling the voltage converter circuit so that the output voltage of the voltage converter circuit becomes a target voltage.

Depending on the circuit systems of the VR controller and the voltage converter circuit, variation of circuit elements configuring internal circuits, and the like, there might occur an error between the output voltage outputted from the switching regulator and the target voltage. For example, Japanese Unexamined Patent Publication No. Hei 9 (1997)-244754 (Patent Document 1) discloses, as a method for correcting variation of the output voltage caused by a conversion error of a digital/analog converter for converting a digital signal indicating the set value of the output voltage of a voltage regulator into an analog signal, a method for correcting the digital signal so as to cancel the deviation between the output voltage measured by a digital voltmeter provided in the voltage regulator and the output set value.

### SUMMARY

Recently, a multi-phase voltage regulator having a plurality of DC/DC converters arranged in parallel has been known as a voltage regulator for CPU. In the system configuration of the multi-phase voltage regulator, a plurality of voltage converter circuits for converting an input voltage into a target voltage and outputting it are coupled in parallel, and controlled by a VR controller. The voltage converter circuits are each comprised of an LC filter comprised of a coil and a capacitor configuring a step-down switching regulator, a switch circuit including a power transistor for controlling a current flowing through the coil, and the like. The VR controller generates and outputs a control signal for controlling the switch circuits of the voltage converter circuits so that the output voltage generated by the voltage converter circuits becomes the target voltage.

One of the power supply standards of the multi-phase voltage regulator for CPU is, for example, VR12. The VR12 requires control (hereinafter referred to as “load line control”) for decreasing the output voltage with increase in the load current of a load coupled to the voltage regulator (the output current of the voltage regulator). The load line control can be implemented e.g. by, in the VR controller, generating an internal current proportional to the load current of the voltage regulator, adjusting a feedback voltage according to the output voltage of the voltage regulator based on the internal current, and inputting the feedback voltage to an error amplifier. In the load line control, the output voltage has to be set within a specified voltage range in accordance with the magnitude of the load current. However, there is variation in the characteristic of the output voltage with respect to the load current (hereinafter also referred to as a load line characteristic), depending on the accuracy with which the VP controller monitors the load current, the accuracy of a circuit according to the generation of the internal current, the offset of the error amplifier, and the like. In the past, to correct the variation in the load line characteristic, circuit elements in the VR controller are trimmed at the time of factory shipment of the VR controller comprised of a semiconductor integrated circuit.

However, further advancement in multifunction and large scale of the voltage regulator (e.g., increase in the number of phases in the multi-phase voltage regulator) by request of improvement in power stability and larger current might increase the variation in the load line characteristic, which might be unable to be coped with by the variation correction in the past. Even if the technique of Patent Document 1 is applied, since according to the technique the output voltage is adjusted independent of the load current, it is difficult to correct the variation in the load line characteristic. The present inventors thought that there is a need for a new technique for reducing the variation of the output voltage in the voltage regulator.

While means for solving such a problem will be described below, the other problems and novel features will become apparent from the description of this specification and the accompanying drawings.

A typical one of the embodiments disclosed in the present application will be briefly described as follows.

The present voltage regulator supplies a power supply voltage to a coupled load and varies the power supply voltage in accordance with a load current of the load. The voltage regulator has a voltage converter circuit for generating and outputting the power supply voltage supplied to the load based on an input voltage and a control unit for controlling the voltage converter circuit. The control unit controls the voltage converter circuit so that an output voltage of the voltage converter circuit becomes a target voltage when the voltage regulator is in a no-load condition, and controls the voltage converter circuit so as to have a transition characteristic in which the output voltage decreases with increase in the load current. Further, the control unit performs first correction processing for calculating the amount of deviation between a measurement value of the output voltage and an ideal value thereof when a load condition of the voltage regulator is a first load condition and correcting the target voltage by the output voltage adjustment unit so that the deviation becomes small, and performs second correction processing for calculating the amount of deviation between a measurement value of a rate of change of the output voltage with respect to the load current and an ideal value thereof and correcting the transition characteristic so that the deviation becomes small.

An effect obtained by the typical one of the embodiments disclosed in the present application will be briefly described as follows.

According to the present voltage regulator, it is possible to reduce variation in the characteristic of the output voltage with respect to the load current.

### BRIEF DESCRIPTION OF THE DRAWINGS

FIG. 1 is a block diagram illustrating a voltage regulator according to an embodiment of the present invention.

FIG. 2 is a block diagram illustrating a data processing system according to a first embodiment.

FIG. 3 is a block diagram illustrating the internal configuration of a voltage converter circuit 11.

FIG. 4 is an explanatory diagram illustrating characteristics of an output voltage VOUT with respect to an output current IOUT in the voltage regulator 1.

FIG. 5 is a diagram for explaining the outline of slope correction processing.

FIG. 6 is a flowchart illustrating the flow of the slope correction processing.

FIG. 7 is an explanatory diagram illustrating a method for adjusting the resistance values of a variable resistance circuit 107 as slope correction.

FIG. 8 is an explanatory diagram illustrating a method for adjusting a current Idroop as slope correction.

FIG. 9 is a diagram for explaining the outline of offset correction processing.

FIG. 10 is a flowchart illustrating the flow of the offset correction processing.

FIG. 11 is an explanatory diagram illustrating a method for adjusting a reference voltage VREF as offset correction.

FIG. 12 is an explanatory diagram illustrating another method for adjusting the reference voltage VREF as offset correction.

FIG. 13 is a flowchart showing an example of the starting sequence of the data processing system 100.

FIG. 14 is a timing chart illustrating various signals in the starting sequence of the data processing system 100.

FIG. 15 is a block diagram illustrating a data processing system according to a second embodiment.

FIG. 16 is a diagram for explaining the outline of dynamic slope correction processing by a VR controller 30.

### DETAILED DESCRIPTION

### 1. Outline of Embodiments

First, exemplary embodiments of the invention disclosed in the present application will be outlined. Reference numerals in the drawings that refer to with parentheses applied thereto in the outline description of the exemplary embodiments are merely illustration of ones contained in the concepts of components marked with the reference numerals.

[1] Voltage Regulator Capable of Correcting Load Line Characteristic

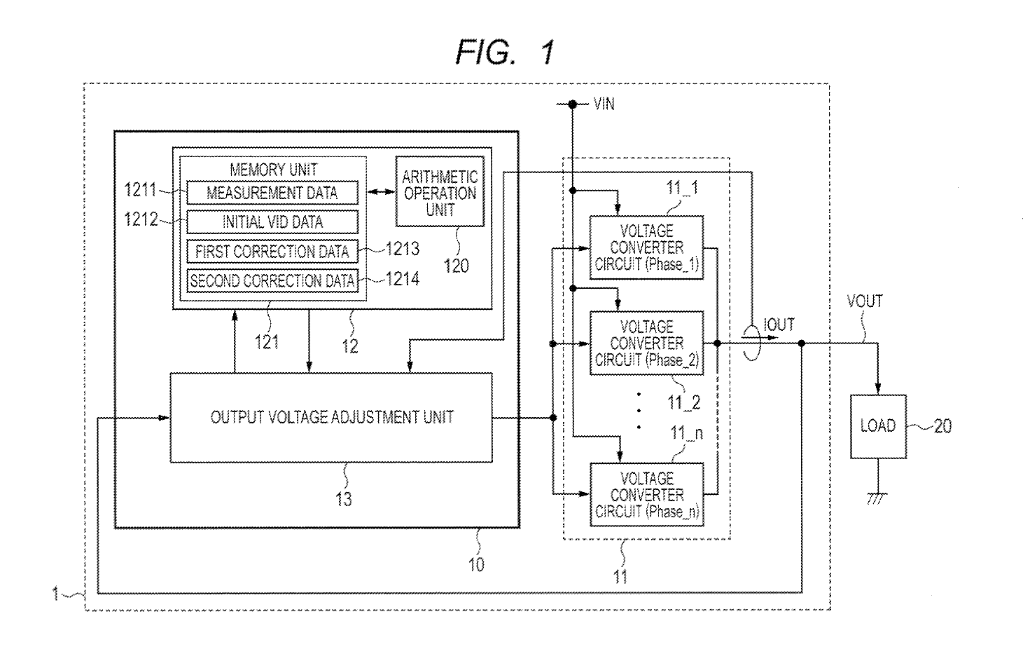

A voltage regulator (1) according to an exemplary embodiment of the present application supplies a power supply voltage (VOUT) to a coupled load (20) and varies the power supply voltage in accordance with a load current (IOUT) of the load, as illustrated in FIG. 1. The present voltage regulator has a voltage converter circuit (11) for generating and outputting the power supply voltage based on an input voltage (VIN) and a control unit (10) for controlling the voltage converter circuit. The control unit has an output voltage adjustment unit (13) which controls the voltage converter circuit so that an output voltage of the voltage converter circuit becomes a target voltage when the voltage regulator is in a no-load condition and controls the voltage converter circuit so as to have a transition characteristic in which the output voltage decreases with increase in the load current and a correction unit (12). The correction unit performs first correction processing for calculating the amount of deviation between a measurement value of the output voltage and an ideal value thereof when a load condition of the voltage regulator is a first load condition (condition in which the output current IOUT is stable) and correcting the target voltage by the output voltage adjustment unit so that the deviation becomes small. The correction unit further performs second correction processing for calculating the amount of deviation between a measurement value of a rate of change of the output voltage with respect to the load current and an ideal value thereof and correcting the transition characteristic so that the deviation becomes small.

According to this, even if the characteristic (load line characteristic) of the output voltage of the voltage regulator deviates from the ideal characteristic due to variation of circuit elements configuring the control unit etc., the control, unit itself corrects the characteristic; therefore, it is possible to reduce variation in load line characteristic between voltage regulators. Further, according to the voltage regulator, the control unit itself can correct the load line characteristic when used by a user; therefore, it is possible to provide the voltage regulator having little variation even without measuring the load line characteristic separately by a tester or the like and trimming circuit elements in the production stage of the control unit etc.

[2] Details of Correction Unit; FIGS. 1, 2, 15

In the voltage regulator according to item 1, the correction unit has an arithmetic operation unit (120), a first storage unit (1213) for storing first correction data for correcting the target voltage, and a second storage unit (1214) for storing second correction data for correcting the transition characteristic. In the first correction processing (offset correction processing), the arithmetic operation unit calculates the amount of deviation between the measurement value of the output voltage and the ideal value at the first load condition, generates the first correction data according to the amount of deviation, and stores the first correction data in the first storage unit. In the second correction processing (slope correction processing), the arithmetic operation unit calculates the amount of deviation between the measurement value of the rate of change of the output voltage with respect to the load current and the ideal value, generates the second correction data according to the amount of deviation, and stores the second correction data in the second storage unit. The output voltage adjustment unit adjusts a control amount of the voltage converter circuit based on values set in the first storage unit and the second storage unit.

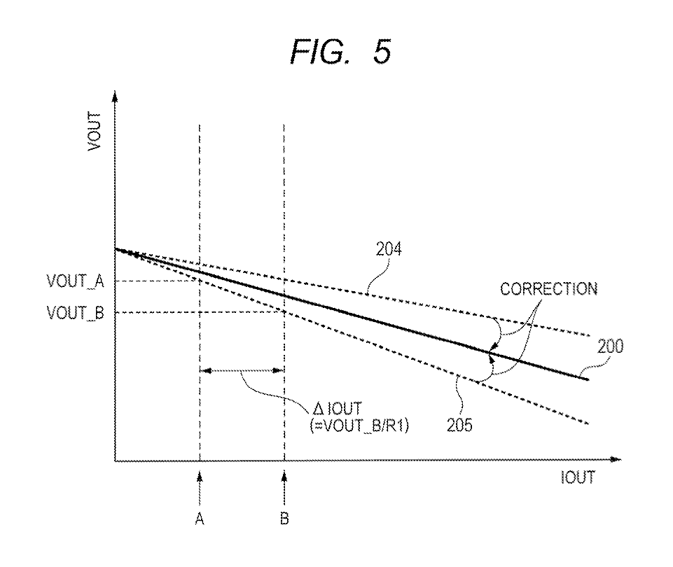

This makes it possible to easily correct the load line characteristic.

[3] Calculation of Slope; FIG. 5

In the voltage regulator according to item 2, in the second correction processing, the arithmetic operation unit calculates the measurement value of the rate of change, based on the measurement value (VOUT_A) of the output voltage at the first load condition (load condition A), a measurement value (VOUT_B) of the output voltage at a second load condition (load condition B) whose load current is larger than that of the first load condition, and the amount of increase (ΔIOUT) of the load current after a transition from the first load condition to the second load condition.

This makes it possible to easily calculate the measurement value of the rate of change according to the transition characteristic.

[4] Calculation of the Amount of Increase of Current

The voltage regulator according to item 3 further has a first resistor (R1) which can be coupled between a node to which the output voltage is supplied and a ground node to which a ground voltage is supplied. In the second correction processing, the arithmetic operation unit couples the first resistor to effect the transition from the first load condition to the second load condition, and calculates the amount of increase (=VOUT_B/R1) of the load current based on the measurement value of the output voltage after the transition and a resistance value of the first resistor.

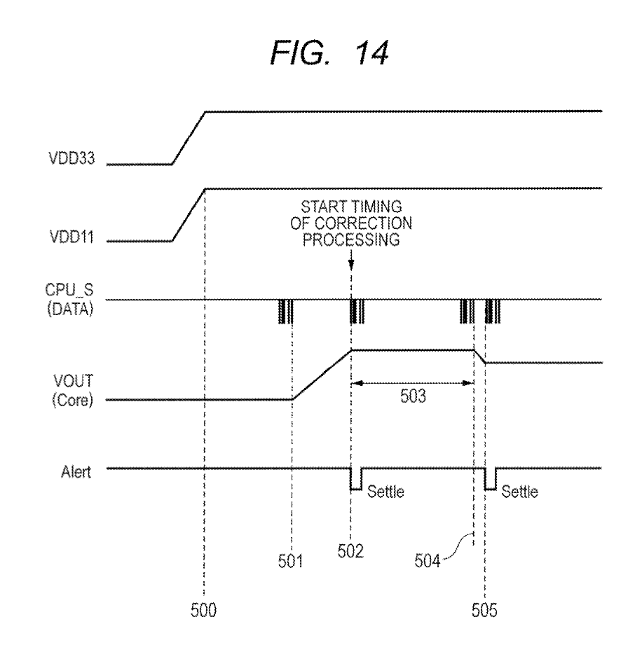

This makes it possible to easily calculate the amount of increase of the output current even without directly measuring the output current.

[5] Start Correction in Response to Notification Signal; FIG. 14

In the voltage regulator according to any one of items 2 to 4, the arithmetic operation unit starts the first correction processing and the second correction processing in response to a predetermined notification signal (response signal to a signal Settle) transmitted from the load.

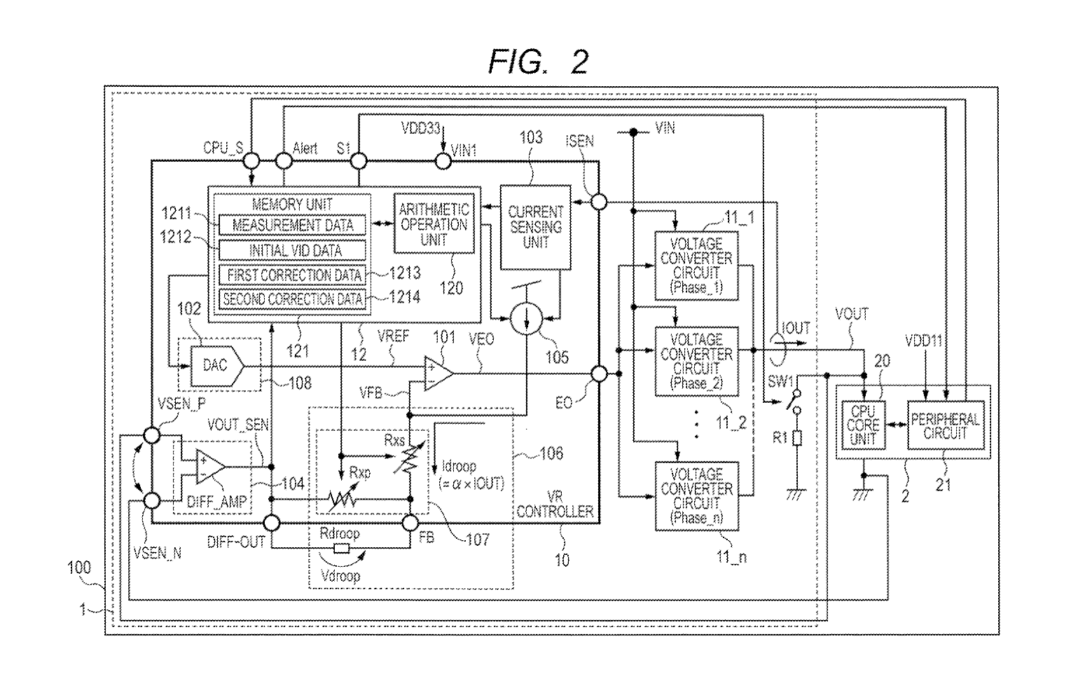

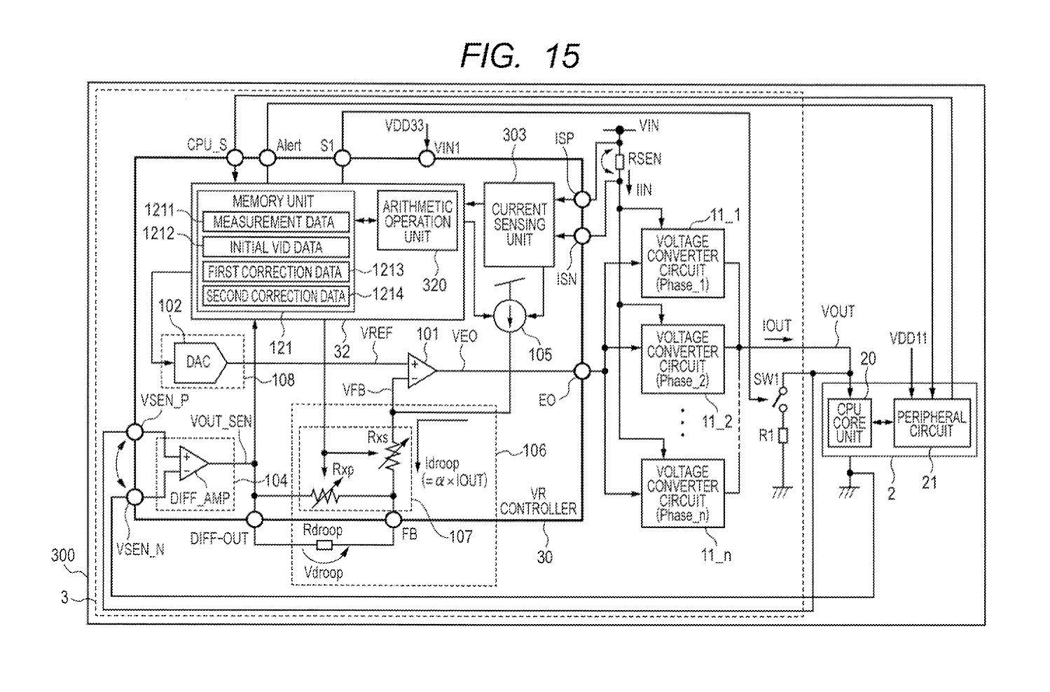

This makes it possible to start the first correction processing and the second correction processing, for example, with timing according to the operating condition of the load.

[6] Details of Output Voltage Adjustment Unit and Correction Unit; FIGS. 2, 15

In the voltage regulator according to any one of items 2 to 5, the output voltage adjustment unit has an error amplifier (101), a current sensing unit (103) for sensing the load current, and a current generation unit (105) for generating a first current (Idroop) according to the load current sensed by the current sensing unit. The output voltage adjustment unit further has a first resistance circuit (106) for converting the first current into a voltage and generating a feedback voltage (VB) obtained by adding the converted voltage to a voltage according to the output voltage of the voltage converter circuit. The error amplifier receives a reference voltage based on the target voltage and the feedback voltage, generates a control signal (VEO) so that an error between two input voltages becomes small, and provides the control signal to the voltage converter circuit.

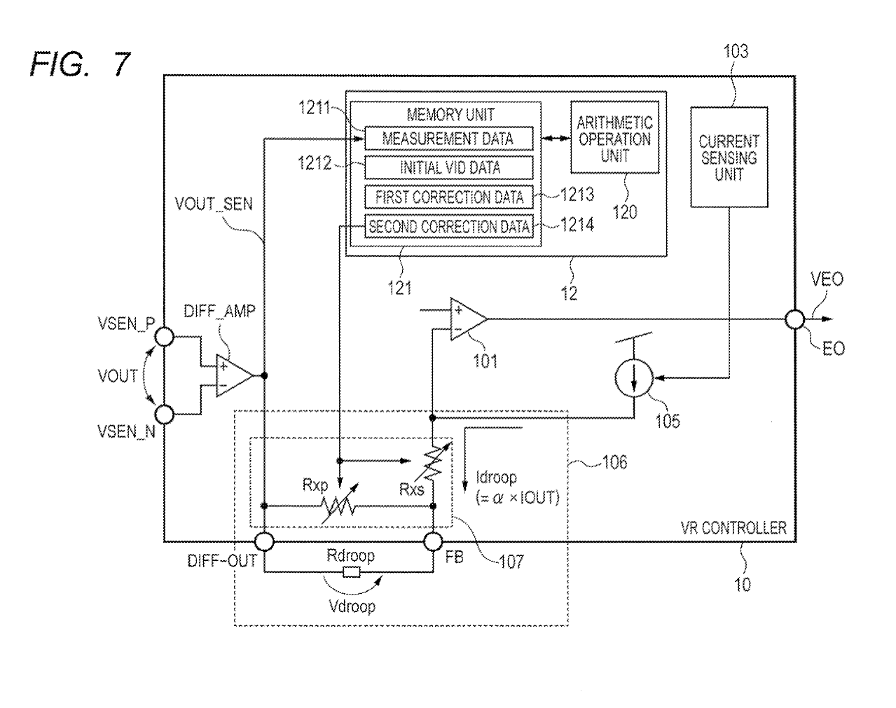

This makes it possible to easily implement load line control.

[7] Slope Correction Method: Adjust Droop Resistor; FIG. 7

In the voltage regulator according to item 6, a resistance value of the first resistance circuit is determined based on the second correction data stored in the second storage unit.

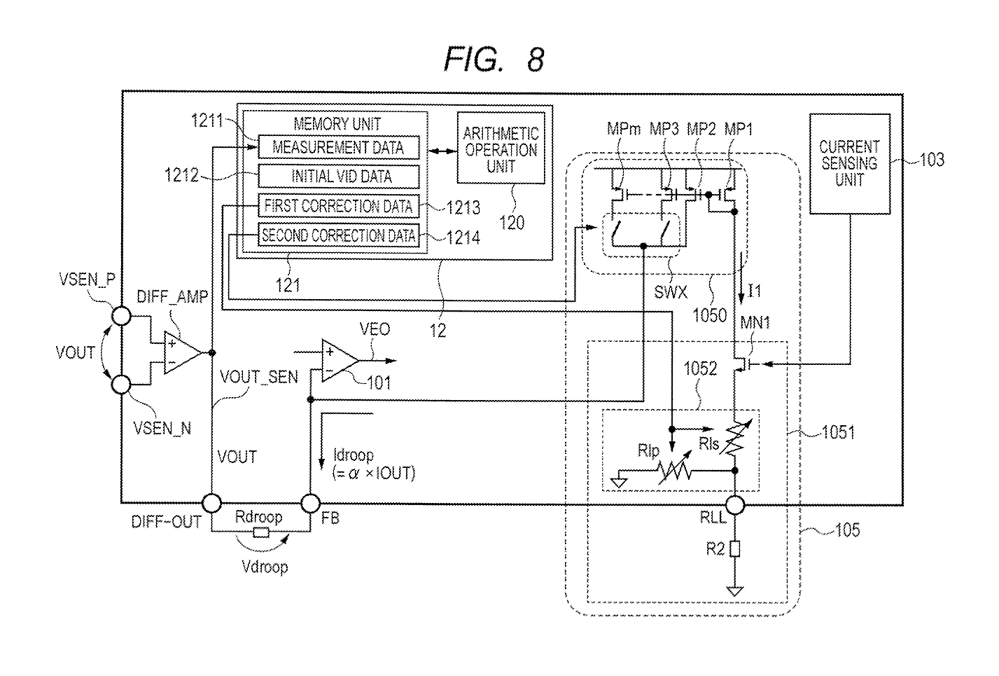

This makes it possible to easily adjust the transition characteristic (the slope of the characteristic of the output voltage with respect to the load current).

[8] Details of Current Generation Unit; FIG. 8

In the voltage regulator according to item 6 or 7, the current sensing unit outputs a voltage according to the sensed load current. Further, the current generation unit has a current source circuit (1051) for generating a second current (11) based on a voltage according to the load current outputted from the current sensing unit and a current mirror unit (1050) for outputting the first current by mirroring the second current at a predetermined mirror ratio. The current source circuit includes a second resistance circuit (1052, R2) for determining a current value of the second current.

This makes it possible to easily generate the first current which varies in accordance with the load current.

[9] Slope Correction Method: Adjust Resistance Value of Current Source Circuit; FIG. 8

In the voltage regulator according to item 8, a resistance value of the second resistance circuit is determined based on the second correction data stored in the second storage unit.

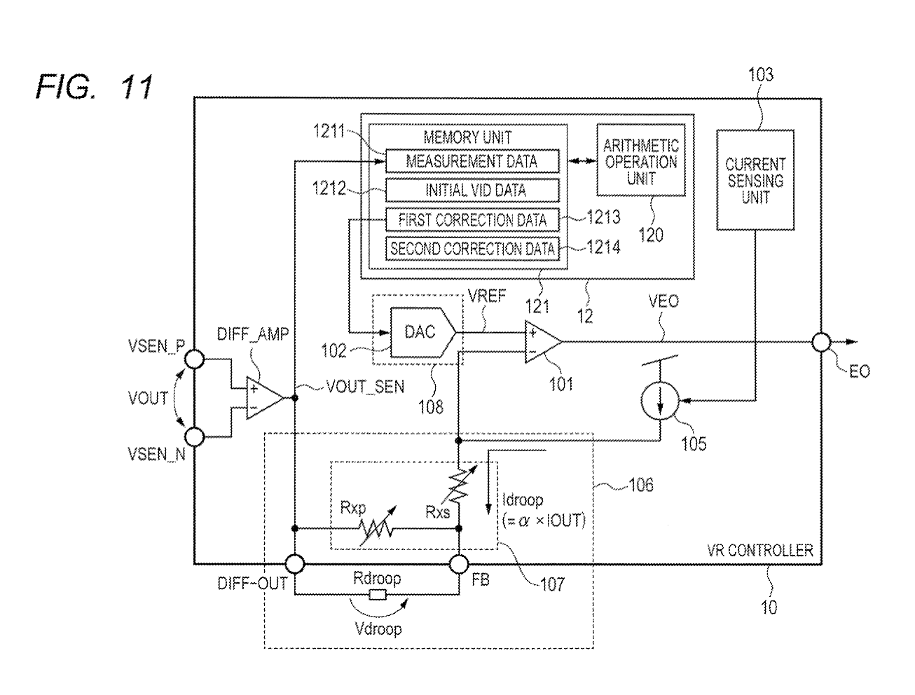

This makes it possible to easily adjust the transition characteristic (slope).

[10] Offset Correction Method: Correct Digital Signal Input to DAC; FIG. 11

In the voltage regulator according to any one of items 2 to 9, the output voltage adjustment unit further has a digital/analog converter (102) for converting an inputted digital signal into an analog signal and outputting the converted analog signal as the reference voltage. The arithmetic operation unit corrects a digital value designating the inputted target voltage based on the amount of deviation calculated in the first correction processing, and stores the corrected digital value in the first storage unit as the first correction data. The digital/analog converter receives the first correction data stored in the first storage unit.

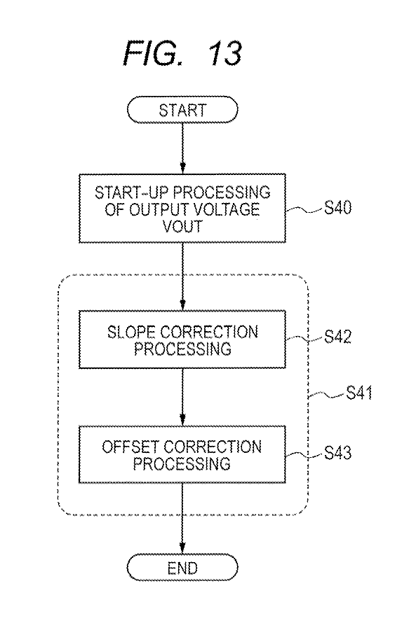

This makes it possible to easily correct the deviation (offset) of the output voltage at the first load condition.

[11] Offset Correction Processing after Slope Correction Processing; FIG. 13

In the voltage regulator according to any one of items 2 to 10, the arithmetic operation unit performs the first correction processing (S43) after performing the second correction processing (S42).

Even if the magnitude of the offset of the output voltage at the first load condition varies before and after the adjustment of the transition characteristic (slope) by the second correction processing, it is possible to accurately correct the load line characteristic.

[12] Monitor Load Current by Input-Side Resistor; FIG. 15

The voltage regulator according to any one of items 2 to 11 further has a second resistor (RSEN) inserted in series with a signal path for supplying the input voltage to the voltage converter circuit. The current sensing unit measures the load current based on a voltage (Vrsen) across the second resistor. The second resistor can be implemented, for example, by a resistance element or the on resistance of a MOS transistor.

Since the output-side current is larger than the input-side current of the voltage converter circuit, the insertion of the load current sensing resistor into the input side of the voltage converter circuit as in the voltage regulator can reduce a loss by the sensing resistor, for example compared to the insertion of a sensing resistor into a signal path to which the output voltage is supplied, and therefore suppress a decrease in the efficiency of the voltage regulator.

[13] Semiconductor Device Capable of Correcting Load Line Characteristic

A semiconductor device (10, 30) according to an exemplary embodiment of the present application generates a control signal (VEO) for controlling a switch circuit (HS_PWMOS, LS_PWMOS) included in a switching regulator (1, 3). The present semiconductor device has an output voltage adjustment unit (101, 103, 104, 105, 106, 108) which generates the control signal so that an output voltage of the switching regulator becomes a target voltage when the switching regulator is in a no-load condition, and generates the control signal so as to have a transition characteristic in which the output voltage decreases with increase in a load current of a load coupled to the switching regulator. The semiconductor device has a correction unit (12) which performs first correction processing for calculating the amount of deviation between a measurement value of the output voltage and an ideal value thereof when a load condition of the switching regulator is a first load condition and correcting the target voltage so that the deviation becomes small, and performs second correction processing for calculating the amount of deviation between a measurement value of a rate of change of the output voltage with respect to the load current and an ideal value thereof and correcting the transition characteristic so that the deviation becomes small.

This makes it possible to reduce variation in load line control between semiconductor devices, as in item 1.

[14] Details of Correction Unit

In the semiconductor device according to item 13, the correction unit has an arithmetic operation unit (120), a first storage unit (1213) for storing first correction data for correcting the target voltage, and a second storage unit (1214) for storing second correction data for correcting the transition characteristic. In the first correction processing, the arithmetic operation unit calculates the amount of deviation between the measurement value of the output voltage and the ideal value at the first load condition, generates the first correction data according to the amount of deviation, and stores the first correction data in the first storage unit, and in the second correction processing, the arithmetic operation unit calculates the amount of deviation between the measurement value of the rate of change of the output voltage with respect to the load current and the ideal value, generates the second correction data according to the amount of deviation, and stores the second correction data in the second storage unit.

This makes it possible to easily correct the load line characteristic.

[15] Signal Output Terminal for Causing Load Condition to Transition; FIGS. 2, 15

The semiconductor device according to item 14 further has a first terminal (S1) for outputting a signal. The arithmetic operation unit outputs to the first terminal a signal that causes the load condition of the switching regulator to transition between the first load condition and a second load condition.

This makes it possible to easily switch the load condition of the voltage regulator between the first load condition and the second load condition. For example, by controlling the coupling and decoupling of a resistance element provided between a node to which the output voltage is supplied and a ground node to which a ground voltage is supplied, using the signal outputted from the first terminal, it is possible to easily switch between the first load condition and the second load condition.

[16] Data Processing System Capable of Correcting Load Line Characteristic

A data processing system (100, 300) according to an exemplary embodiment of the present application has a data processor (2) and a voltage regulator (1, 3) for generating a power supply voltage (VOUT) supplied to the data processor. The voltage regulator has a voltage converter circuit (11, 11_1 to 11_{—}n) for generating and outputting the power supply voltage based on an input voltage (VIN) and a control unit (10) for controlling the voltage converter circuit. The control unit has an output voltage adjustment unit (101, 103, 104, 105, 106, 108) which controls the voltage converter circuit so that an output voltage of the voltage converter circuit becomes a target voltage when the data processor is in a first operating condition, and controls the voltage converter circuit so as to have a transition characteristic in which the output voltage decreases with increase in a consumption current. The control unit further has a correction unit (12) which performs first correction processing for calculating the amount of deviation between a measurement value of the output voltage and an ideal value thereof at the first operating condition and correcting the target voltage by the output voltage adjustment unit so that the deviation becomes small, and performs second correction processing for calculating the amount of deviation between a measurement value of a rate of change of the output voltage with respect to the consumption current and an ideal value thereof and correcting the transition characteristic so that the deviation becomes small.

This makes it possible to reduce variation in load line characteristic between data processing systems, as in item 1.

[17] Details of Correction Unit

In the data processing system according to item 16, the correction unit has an arithmetic operation unit (120), a first storage unit (1213) for storing first correction data for correcting the target voltage, and a second storage unit (1214) for storing second correction data for correcting the transition characteristic. In the first correction processing, the arithmetic operation unit calculates the amount of deviation between the measurement value of the output voltage and the ideal value at the first operating condition, generates the first correction data according to the amount of deviation, and stores the first correction data in the first storage unit. Further, in the second correction processing, the arithmetic operation unit calculates the amount of deviation between the measurement value of the rate of change of the output voltage with respect to the consumption current and the ideal value, generates the second correction data according to the amount of deviation, and stores the second correction data in the second storage unit. The output voltage adjustment unit adjusts a control amount of the voltage converter circuit based on values set in the first storage unit and the second storage unit.

This makes it possible to easily correct the load line characteristic.

[18] VID Data

In the data processing system according to item 17, the data processor has a CPU core unit (20) which operates by being supplied with the output voltage and a communication unit (21) which operates by being supplied with a power supply voltage (VDD11) different from the output voltage and can communicate with the control unit. The communication unit transmits first data (VID data) designating a set value of the output voltage. The output voltage adjustment unit determines the target voltage based on the received first data and controls the voltage converter circuit.

This makes it possible to easily vary the output voltage even after the production of the control unit and the voltage regulator.

[19] Correct in Stable Load Condition; FIG. 14

In the data processing system according to item 18, the arithmetic operation unit performs the first correction processing and the second correction processing during a time period when a consumption current of the CPU core unit is stable.

This makes it possible to improve the accuracy of measuring the output voltage and the load current.

[20] Start Correction after Power-on; FIG. 14

In the data processing system according to item 18 or 19, the arithmetic operation unit starts the first correction processing and the second correction processing when the output voltage has reached the target voltage after receiving the first data transmitted first after power is applied to the control unit.

According to this, the first correction processing and the second correction processing are performed after power is applied to the data processing system; therefore, it is possible to reduce variation in load line characteristic even without trimming or the like in the production stage.

[21] Multi-Phase Voltage Regulator; FIGS. 2, 15

In the voltage regulator according to any one of items 1 to 12, n (n is an integer not less than 2) voltage converter circuits are coupled in parallel. Further, the output voltage adjustment unit controls the voltage converter circuits.

This makes it possible to reduce variation in load line characteristic in the multi-phase voltage regulator as well.

[22] Slope Correction Method: Adjust Mirror Ratio of Current Mirror; FIG. 8

In the voltage regulator according to any one of items 8 to 12 and 21, the predetermined mirror ratio of the current mirror unit is determined based on the second correction data stored in the second storage unit.

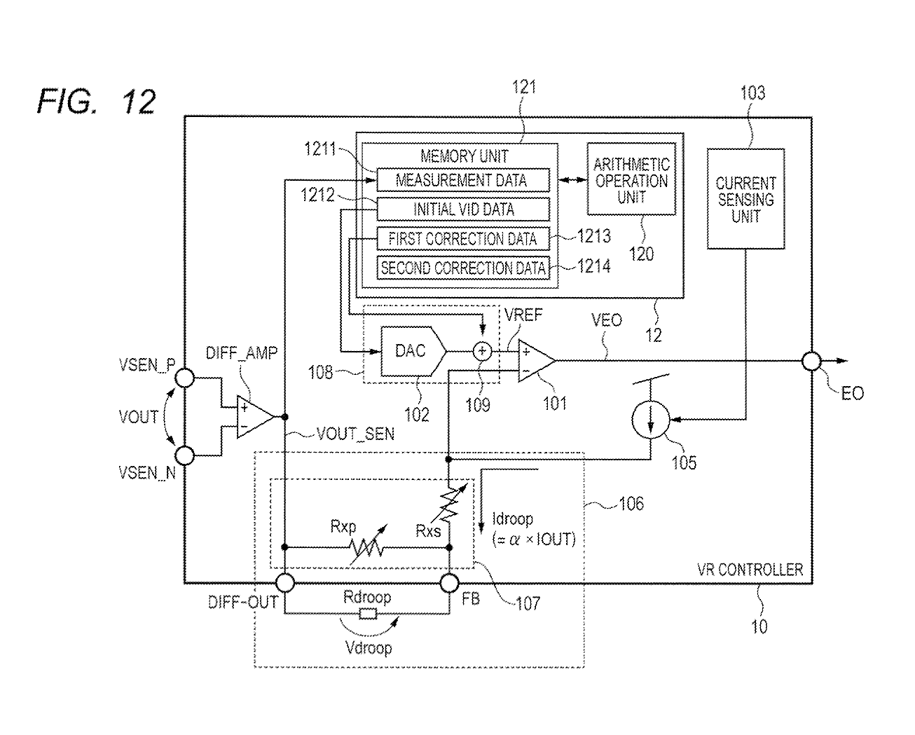

This makes it possible to easily adjust the transition characteristic (slope).

[23] Offset Correction Method: Correct Output Signal of DAC and Input to EA; FIG. 12

In the voltage regulator according to any one of items 6 to 9 and 11, 12, 21, and 22, the output voltage adjustment unit has a digital/analog converter (102) for converting a digital signal designating the inputted target voltage into an analog signal. The output voltage adjustment unit further has a reference voltage correction unit (109) for correcting the analog signal converted by the digital/analog converter based on the first correction data stored in the first storage unit and inputting the corrected voltage to the error amplifier as the reference voltage.

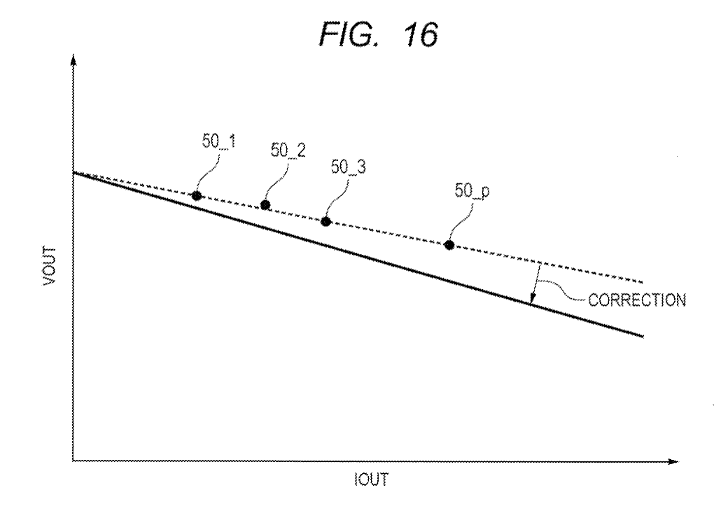

This makes it possible to easily correct the deviation (offset) of the output voltage at the first load condition.

[24] Slope Correction During Operation of CPU Core Unit; FIG. 16

In the voltage regulator (3) according to any one of items 2 to 12 and 21 to 23, the arithmetic operation unit (320) measures the load current and the output voltage multiple times (p times (p is an integer not less than 2)) with predetermined timings at a load condition whose load current is larger than that of the first load condition, and performs the second correction processing based on the measured load current and output voltage values.

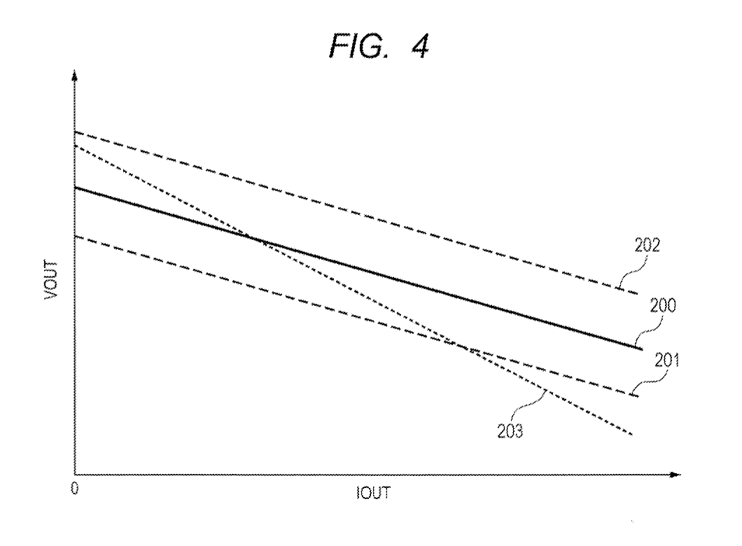

This makes it possible to correct the transition characteristic even at varying load current.

[25] Calculation of Slope; FIG. 4

In the semiconductor device according to item 14 or 15, in the second correction processing, the arithmetic operation unit, the arithmetic operation unit calculates the measurement value of the rate of change, based on the measurement value (VOUT_A) of the output voltage at the first load condition (load condition A), a measurement value (VOUT_B) of the output voltage at a second load condition (load condition B) whose load current is larger than that of the first load condition, and the amount of increase (ΔIOUT) of the load current after a transition from the first load condition to the second load condition.

This makes it possible to easily calculate the measurement value of the rate of change according to the transition characteristic.

[26] Offset Correction Processing after Slope Correction Processing; FIG. 13

In the semiconductor device according to item 14, 15 or 25, the arithmetic operation unit performs the first correction processing (S43) after performing the second correction processing (S42).

This makes it possible to accurately correct the load line characteristic, as in item 11.

### 2. Details of Embodiments

Embodiments will be described in greater detail below.

### First Embodiment

FIG. 2 is a block diagram illustrating a data processing system according to the first embodiment.

The data processing system 100 shown in FIG. 2 is, for example, a personal computer. More specifically, the data processing system 100 is comprised of a data processor 2 for performing various kinds of data processing, a voltage regulator 1 for supplying power to the data processor 2, and other peripheral circuits such as interface circuits (not shown).

The data processor 2 has a CPU core unit 20 as a program processing execution entity in the data processing system 100 and a peripheral circuit 21 for executing specific processing for the CPU core unit 20. Although the details will be described later, the peripheral circuit 21 performs communication processing for transmitting/receiving data to/from a VR controller 10 in the voltage regulator 1. The CPU core unit 20 and the peripheral circuit 21 operate, for example, supplied with different power supply voltages. For example, the CPU core unit 20 is powered by an output voltage VOUT supplied from the voltage regulator 1, and the peripheral circuit 21 is powered by a power supply voltage VDD11 (e.g., 1.1 V) supplied from a voltage regulator (not shown) different from the voltage regulator 1.

Although not restricted, the voltage regulator 1 comprises a multi-phase voltage regulator having a plurality of DC/DC converters arranged in parallel. For example, the voltage regulator 1 complies with VR12 which is a power supply standard of the multi-phase voltage regulator for CPU, and generates the output voltage VOUT by the load line control.

More specifically, the voltage regulator 1 is comprised of n (n is an integer not less than 2) parallel-coupled voltage converter circuits 11_1 to 11_{—}n for converting an input voltage VIN into a desired voltage VOUT and outputting the voltage VOUT, the VR controller 10 for controlling the voltage converter circuits 11_1 to 11_{—}n, and other peripheral circuits.

The voltage converter circuits 11_1 to 11_{—}n (also generically called a voltage converter circuit 11) are each comprised of functional units for implementing a step-down switching regulator.

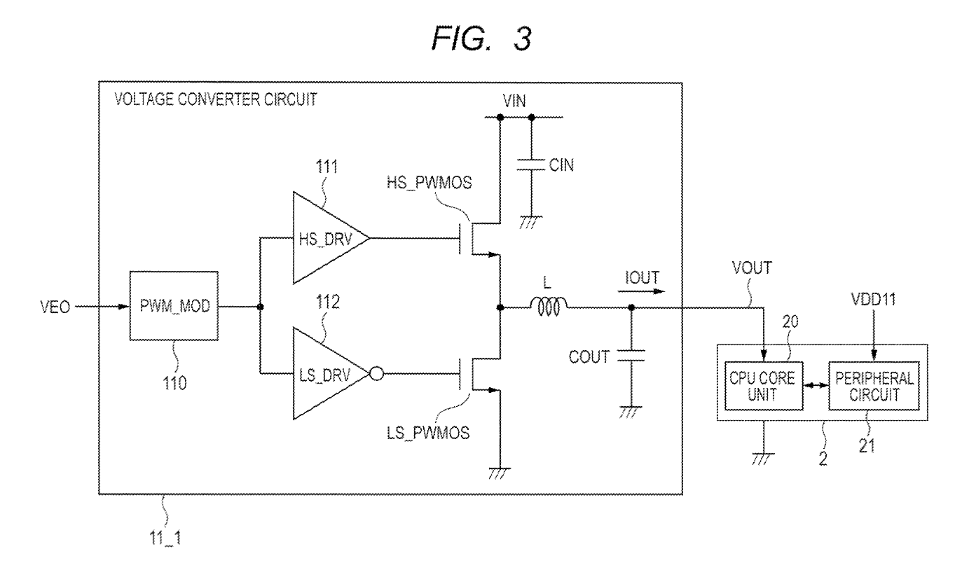

FIG. 3 illustrates a block diagram of the voltage converter circuit 11. While FIG. 3 representatively shows the internal circuit of the voltage converter circuit 11_1, the other voltage converter circuits 11_2 to 11_{—}n have the same circuit configuration. As shown in FIG. 3, the voltage converter circuit 11 is comprised of, for example, a PWM signal generation unit (PWM_MOD) 110, a high-side driver circuit (HS_DRV) 111, a low-side driver circuit (LS_DRV) 112, a high-side power transistor HS_PWMOS, a low-side power transistor LS_PWMOS, an input capacitor CIN, an output capacitor COUT, and a coil L. The PWM signal generation unit 110 generates a PWM signal based on a control signal VEO outputted from an error amplifier 101 in the VR controller 10 described later. The PWM signal generation unit 110 compares the control signal VEO with e.g. a ramp signal as a reference, and outputs a signal according to the comparison result, as the PWM signal. The high-side driver circuit 111 controls on/off of the high-side power transistor HS_PWMOS based on the PWM signal generated by the PWM signal generation unit 110. In the same way, the low-side driver circuit 112 controls on/off of the low-side power transistor LS_PWMOS based on the PWM signal generated by the PWM signal generation unit 110. The on/off control of the high-side power transistor HS_PWMOS and the low-side power transistor LS_PWMOS controls a current flowing through the coil L to generate the output voltage VOUT lower than the input voltage VIN. Although not restricted, the PWM signal generation unit 110, the high-side driver circuit 111, the low-side driver circuit 112, the high-side power transistor HS_PWMOS, and the low-side power transistor LS_PWMOS are comprised of, for example, a plurality of IC chips, and configured as SIP (System in Package) which seals these IC chips in one package.

The voltage regulator 1 includes, for example, a switch circuit SW1 and a resistor R1 as peripheral circuits other than the voltage converter circuit 11 and the VR controller 10. As for the resistor R1 (reference symbol R1 represents not only a resistance element but also a resistance value thereof), for example one end is coupled to a ground node, and the other end is coupled to the switch circuit SW1. The switch circuit SW1 is coupled between the resistor R1 and a signal line to which the output voltage VOUT is supplied. The on/off of the switch circuit SW1 is controlled by a control signal outputted through a terminal S1 from a data processing control unit 12 described later. Although the details will be described later, the switch circuit SW1 is turned off during the normal operation of the data processing system 100, and on/off switching is controlled in slope correction processing described later.

The VR controller 10 generates the control signal VEO for controlling the pulse width of the PWM signal generated by the voltage converter circuits 11_1 to 11_{—}n, thereby implementing the load line control and performing correction so that the output voltage VOUT has a desired load line characteristic.

The VR controller 10 is comprised of internal circuits such as the error amplifier 101, a reference voltage generation unit 108, a current sensing unit 103, a voltage sensing unit 104, a current generation unit 105, a resistance circuit 106, and the data processing control unit 12 and a plurality of external terminals. The external terminals includes, for example, a terminal CPU_S, a terminal Alert, a terminal VIN1, a terminal ISEN, a terminal S1, a terminal EO, a terminal FB, a terminal DIFF_OUT, a terminal VSEN_P, a terminal VSEN_N, and other terminals (not shown).

Although not restricted, the VR controller 10 is comprised of a semiconductor integrated circuit formed over a single semiconductor substrate made of, e.g., monocrystalline silicon, using a known CMOS integrated circuit manufacturing technology. Further, in the configuration of the VP controller 10, all functional units including the data processing control unit 12 may be implemented in a single chip, or the data processing control unit 12 and the other functional units may be implemented in different chips.

The VR controller 10 operates at a power supply voltage VDD33 (e.g., 3.3 V) supplied through the terminal VIN1. The voltage sensing unit 104 senses the output voltage VOUT of the voltage regulator 1. The voltage sensing unit 104 is comprised of, for example, a differential amplifier DIFF_AMP. The terminal VSEN_P is coupled to a signal line to which the output voltage VOUT is supplied, and the terminal VSEN_N is coupled to the ground line of the CPU core unit 20. The differential amplifier DIFF_AMP outputs the difference between the respective voltages supplied to the terminals VSEN_P and VSEN_N, that is, the difference between the output voltage VOUT and the ground voltage of the CPU core unit 20. This makes it possible to accurately sense the voltage supplied between the power and ground lines of the CPU core unit 20. A voltage outputted from the differential amplifier DIFF_AMP is provided to the data processing control unit 12 as a sense voltage VOUT_SEN representing the output voltage VOUT, and also outputted through the terminal DIFF_OUT.

The error amplifier 101 receives a reference voltage VREF generated by the reference voltage generation unit 108 and a feedback voltage VFB of the output voltage VOUT, and generates the control signal VEO so that the error between the two input voltages becomes small. The control signal VEO is outputted through the terminal EO and supplied to the PWM signal generation unit 110 in the voltage converter circuits 11_1 to 11_{—}n. The terminal FB is a terminal for feeding back the output voltage VOUT to the error amplifier 101.

The reference voltage generation unit 108 generates the reference voltage VREF based on a target voltage to be outputted as the output voltage VOUT by the voltage regulator 1. Although not restricted, the reference voltage generation unit 108 includes, for example, a digital/analog converter (DAC) 102. The digital/analog converter 102 converts a digital signal (VID data described later) designating the target voltage to be outputted as the output voltage VOUT into an analog signal and outputs the analog signal. The converted analog signal is inputted to the error amplifier 101 as the reference voltage VREF.

The current sensing unit 103 senses an output current IOUT (load current) flowing through the signal line to which the output voltage VOUT is supplied. The current sensing unit 103 outputs, for example, information (hereinafter referred to as sense current information) indicating the magnitude of the sensed output current IOUT. The sense current information is outputted as a voltage value according to the magnitude of the sensed output current IOUT. The terminal ISEN is a terminal for inputting a sense signal according to the output current IOUT. A sensing method by the current sensing unit 103 may be any method as long as it can sense the magnitude of the output current IOUT. For example, the output current IOUT may be sensed from a voltage across a resistor inserted into the signal line to which the output voltage VOUT is supplied. Alternatively, the output current IOUT may be sensed based on a current flowing through the source side of the low-side power transistor LS_PWMOS in the voltage converter circuits 11_1 to 11_{—}n or based on the output voltage of the error amplifier 101.

The current generation unit 105 generates a current according to the output current IOUT sensed by the current sensing unit 103. Although the details will be described later, the current generation unit 105 generates, for example, a current Idroop (=α×IOUT) proportional to the output current IOUT. The generated current Idroop is inputted to the resistance circuit 106.

The resistance circuit 106 is comprised of an external resistor Rdroop coupled between the terminal DIFF_OUT and the terminal FB and a variable resistance circuit 107. The variable resistance circuit 107 is comprised of, for example, a resistor Rxp coupled in parallel with the external resistor Rdroop and a resistor Rxs coupled in series with the external resistor Rdroop. Although the details will be described later, the resistance values of the resistor Rxp and the resistor Rxs can be adjusted by the data processing control unit 12. The current Idroop supplied from the current generation unit 105 flows through the resistor Rxs and through the external resistor Rdroop and the resistor Rxp and flows into the output terminal of the differential amplifier DIFF_AMP. For example, as the output current IOUT (load current) increases, the current Idroop increases and a voltage Vdroop increases proportionately. That is, the feedback voltage VFB to the error amplifier 101 is a voltage obtained by adding a voltage dropped by the resistance circuit 106 to the sense voltage VOUT_SEN (≈output voltage VOUT). Therefore, the error amplifier 101 generates the control signal VEO so that the output voltage VOUT decreases by the voltage Vdroop.

Letting VOUT_{—}0 A be an output voltage when IOUT=0 A (no load) and letting Rxs=0Ω and Rxp>>Rdroop, the output voltage VOUT is expressed by the following equation (1).

$$\begin{matrix}VOUT = VOUT\_ 0 A - Rdroop \times Idroop \\ = VOUT\_ 0 A - α \cdot Rdroop \cdot IOUT\end{matrix} \qquad ( 1 )$$

FIG. 4 illustrates characteristics of the output voltage VOUT with respect to the output current (load current) IOUT in the voltage regulator 1. In FIG. 4, reference numeral 200 represents a load line characteristic (ideal characteristic) expressed by the equation (1). Thus, the above control by the VR controller 10 achieves the load line characteristic in which the output voltage decreases with increase in the load current.

The data processing control unit 12 performs overall control of the whole voltage regulator 1, and also performs communication with the data processor 2. Further, the data processing control unit 12 has the function of correcting the load line characteristic of the voltage regulator 1. The data processing control unit 12 is comprised of, for example, an arithmetic operation unit 120, a memory unit 121, and other peripheral circuits (not shown). The data processing control unit 12 is implemented, for example, by a microcontroller (MCU), a DSP (Digital Signal Processor), and the like.

The arithmetic operation unit 120 is comprised of, for example, a memory such as a ROM or RAM for storing programs and a processor core unit such as a CPU for executing various kinds of data processing based on a program read from the ROM or RAM. Although the details will be described later, the arithmetic operation unit 120 executes various kinds of arithmetic operations for performing correction so that the load line characteristic of the voltage regulator 1 approaches the ideal characteristic. Further, the arithmetic operation unit 120 performs communication with the peripheral circuit 21 in the data processor 2 through the terminal CPU_S and the terminal Alert for example.

The terminal CPU_S is a terminal for receiving various kinds of control data for controlling the voltage regulator 1 which are transmitted from the data processor 2. The various kinds of control data include information (hereinafter also referred to as VID data) designating the target voltage to be outputted by the voltage regulator 1 and response information to a signal transmitted from the data processing control unit 12. Although not restricted, the VID data transmitted from the data processor 2 is, for example, information designating the target voltage (VOUT_{—}0 A) of the output voltage VOUT when the output current IOUT is 0 A (no-load condition), and is hereinafter referred to as initial VID data.

The terminal Alert is a terminal for communication between the VB controller 10 and the data processor 2. Although not restricted, the terminal. Alert is a terminal for one-way communication from the VR controller 10 to the data processor 2. For example, the arithmetic operation unit 120 transmits, through the terminal Alert to the data processor 2, responses to various kinds of control data transmitted from the data processor 2.

The memory unit 121 includes a plurality of storage units for storing various kinds of data according to the correction of the load line characteristic. Although not restricted, the storage units are comprised of a plurality of registers comprised of a plurality of flip-flops and flash memories having nonvolatile storage areas. In FIG. 2, a first storage unit 1211, a second storage unit 1212, a third storage unit 1213, and a fourth storage unit 1214 are representatively illustrated as the storage units in the memory unit 121.

The first storage unit 1211 stores measurement data of the output voltage VOUT of the voltage regulator 1. Further, the first storage unit 1211 also can store measurement data of the output current IOUT as necessary. For example, the first storage unit 1211 stores the value of the sense voltage VOUT_SEN outputted from the differential amplifier DIFF_AMP, as data of the output voltage VOUT. Further, the first storage unit 1211 also can store the value of the output current IOUT sensed by the current sensing unit 103, as measurement data of the output current.

The second storage unit 1212 stores the initial VID data received from the terminal CPU_S. Although the details will be described later, the third storage unit 1213 stores first correction data for correcting offset (the amount of deviation of the value of an output voltage from an ideal value at a given output current) in the load line characteristic. Although the details will be described later, the fourth storage unit 1214 stores second correction data for correcting a slope in the load line characteristic.

The correction of the load line characteristic by the data processing control unit 12 will be described.

As shown in FIG. 4, it is necessary that the load line characteristic of the voltage regulator 1 be within a voltage range predetermined by the specification (VR12) (e.g., the range between reference numeral 201 and reference numeral 202). However, as described above, there is variation between voltage regulators 1, depending on the accuracy with which the VR controller 10 monitors the load current, the accuracy of the generated current Idroop, the offset of the error amplifier 101, and the like, so that the load line characteristic might be outside the predetermined voltage range as shown by reference numeral 203 for example. Therefore, the data processing control unit 12 performs correction processing so that the load line characteristic (e.g., reference numeral 203) of the voltage regulator 1 approaches the ideal characteristic (reference numeral 200).

The correction processing by the data processing control unit 12 includes, for example, offset correction processing and slope correction processing. The offset correction processing is, for example, processing for calculating the amount of deviation between the measurement value of the output voltage VOUT and the ideal value at a given load condition and correcting the reference voltage inputted to the error amplifier 101 so that the deviation becomes small. The slope correction processing is processing for calculating the amount of deviation between the measurement value of the rate of change of the output voltage VOUT with respect to the output current IOUT and the ideal value and correcting the slope of the load line characteristic so that the deviation becomes small.

First, the slope correction processing will be detailed.

FIG. 5 is a diagram for explaining the outline of the slope correction processing. If the slope of the load line characteristic of the voltage regulator 1 deviates from that of the ideal characteristic 200 as shown by reference numeral 204 or 205 in FIG. 5, the slope correction processing corrects the slope deviation so that the slope of the load line characteristic of the voltage regulator 1 approaches that of the ideal characteristic 200. More specifically, the slope correction processing calculates the rate (slope) of change of the output voltage VOUT with respect to the output current IOUT based on measurement data and calculates the amount of deviation from the ideal slope, and changes circuit constants of a circuit block for determining the slope so that the amount of deviation becomes small.

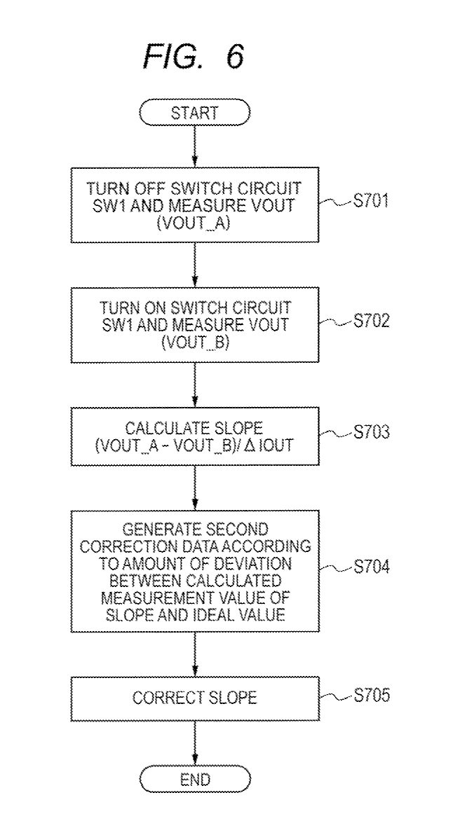

FIG. 6 is a flowchart illustrating the flow of the slope correction processing.

First, the arithmetic operation unit 120 in the data processing control unit 12 measures the output voltage VOUT in a condition in which the output current IOUT is stable (S701). Although not restricted, the condition in which the output current TOUT is stable refers to a condition in which the CPU core unit 20 is not executing full-fledged program processing which is objective processing in the data processor 2. This condition is, for example, a condition in which necessary preparation processing is being performed before the CPU core unit 20 starts the full-fledged program processing immediately after power is applied to the data processing system 100 as described later, a condition in which an operation clock signal is not supplied to the CPU core unit 20, a condition in which a reset signal is supplied to the CPU core unit 20, or the like.

In step 701, specifically the arithmetic operation unit 120 turns off the switch circuit SW1 coupled to the signal line to which the output voltage VOUT is supplied, and stores in the first storage unit 1211 the sense voltage VOUT_SEN of the differential amplifier DIFF_AMP of this time. For example, the arithmetic operation unit 120 stores in the first storage unit 1211 the measurement data of an output voltage VOUT_A at a load condition A in FIG. 5.

Then, the arithmetic operation unit 120 turns on the switch circuit SW1 and measures the output voltage VOUT (S702) in the condition in which the output current IOUT is stable as in step 701. By turning on the switch circuit SW1, the resistor R1 is coupled between the signal line to which the output voltage VOUT is supplied and the ground node. Thereby, the output current IOUT increases by a current flowing through the resistor R1. Thus, by coupling the resistor R1 in parallel with the CPU core unit 20, it is possible to easily produce a load condition B whose current is larger than that of the load condition A in which the output current IOUT is stable. The arithmetic operation unit 120 stores in the first storage unit 1211 the measurement data of an output voltage VOUT_B at the load condition B.

Then, the arithmetic operation unit 120 calculates a slope (S703). More specifically, the arithmetic operation unit 120 calculates the amount of change ΔVOUT of the output voltage VOUT based on the value of the output voltage VOUT_A and the value of the output voltage VOUT_B stored in the first storage unit 1211, and also calculates the amount of change ΔIOUT of the output current IOUT. The amount of change ΔVOUT of the output voltage VOUT is obtained, for example, by calculating “VOUT_A−VOUT_B”. The amount of change ΔIOUT of the output current IOUT is obtained, for example, by calculating “VOUT_B/R1”. This makes it possible to obtain the amount of change ΔIOUT of the output current IOUT even without directly measuring the output current IOUT. Then, the arithmetic operation unit 120 calculates the measurement value of the slope by calculating “ΔVOUT/ΔIOUT” using the calculated amounts of changes ΔVOUT and ΔIOUT.

Then, the arithmetic operation unit 120 calculates the amount of deviation between the calculated measurement value of the slope and the ideal value of the slope in the load line characteristic, and calculates the correction data of the slope according to the amount of deviation (S704). The calculated correction data is stored in the fourth storage unit 1214 as the second correction data. Then, circuit constants of a circuit block for determining the magnitude of the slope are changed based on the second correction data stored in the fourth storage unit 1214, thereby correcting the slope (S705).

Hereinafter, two methods are representatively illustrated as methods for adjusting circuit constants of circuit blocks based on the second correction data.

FIG. 7 is an explanatory diagram illustrating a method for adjusting the resistance values of the variable resistance circuit 107 as slope correction.

In FIG. 7, a value for designating the resistance values of the variable resistance circuit 107 is set in the fourth storage unit 1214 as the second correction data. The resistors Rxs and Rxp of the variable resistance circuit 107 have circuit configurations in which the resistance values are determined by the value in the fourth storage unit 1214. For example, the resistors Rxs and Rxp are comprised of a plurality of resistance elements and a plurality of switch elements coupled in parallel or series with the resistance elements, and the resistance values of the resistors Rxs and Rxp are determined by turning on or off the switch elements in accordance with the value in the fourth storage unit 1214.

For example, if the absolute value of the calculated measurement value of the slope is larger than the absolute value of the ideal value in an initial state (Rxs=0Ω and Rxp>>Rdroop) of the variable resistance circuit 107, the arithmetic operation unit 120 generates the second correction data that makes the resistance value of the resistance circuit 106 (the combined resistance value of the external resistor Rdroop and the variable resistance circuit 107) smaller than the resistance value of the external resistor Rdroop. That is, the arithmetic operation unit 120 generates the second correction data that decreases the resistor Rxp. On the other hand, if the absolute value of the calculated measurement value of the slope is smaller than the absolute value of the ideal value, the arithmetic operation unit 120 generates the second correction data that makes the resistance value of the resistance circuit 106 larger than the resistance value of the external resistor Rdroop. That is, the arithmetic operation unit 120 generates the second correction data that increases the resistor Rxs. Thereby, the slope is corrected.

FIG. 8 is an explanatory diagram illustrating a method for adjusting the current Idroop as slope correction.

As shown in FIG. 8, the current generation unit 105 is comprised of, for example, a current mirror unit 1050 and a current source circuit 1051. The current source circuit 1051 is a circuit for generating a current based on the sense current information outputted from the current sensing unit 103. Although not restricted, the current source circuit 1051 is comprised of, for example, a transistor MIN1, a variable resistance circuit 1052, and an external resistor R2, as shown in FIG. 8. The transistor MIN1 is, for example, an N-channel MOS transistor, and generates at its source a voltage according to the sense current information (voltage) outputted from the current sensing unit 103. The source of the transistor MIN1 is coupled to the variable resistance circuit 1052. The variable resistance circuit 1052 is comprised of a resistor R1s and a resistor Rip whose resistance values are adjustable. One end of the resistor R1s is coupled to the source of the transistor MIN1, and the other end is coupled to a terminal RLL. One end of the resistor R1p is coupled to the terminal RLL, and the other end is coupled to the ground node. The external resistor R2 is coupled between the terminal RLL and the external ground node. Thereby, a current I1 is generated. The magnitude of the current I1 is determined by the voltage at the source of the transistor MIN1 and the combined resistance value of the variable resistance circuit 1052 and the external resistor R2. The current I1 generated by the current source circuit 1051 is mirrored by the current mirror unit 1050 to output the current Idroop. The current mirror unit 1050 is comprised of, for example, a plurality of P-channel MOS transistors MP1 to MPm (m is an integer equal to or greater than 2) and a switch circuit SWX for switching a mirror ratio.

Methods for adjusting the current Idroop can include a method for adjusting the mirror ratio of the current mirror unit 1050 and a method for adjusting the resistance value of the variable resistance circuit 1052.

In the method for adjusting the mirror ratio of the current mirror unit 1050, a value for designating the mirror ratio of the current mirror unit 1050 is set in the fourth storage unit 1214 as the second correction data. In this case, the mirror ratio of the current mirror unit 1050 can be changed by turning on or off switch elements in the switch circuit SWX in accordance with the value in the fourth storage unit 1214. For example, if the absolute value of the calculated measurement value of the slope is larger than the absolute value of the ideal value, the arithmetic operation unit 120 sets the second correction data that decreases the mirror ratio. On the other hand, if the absolute value of the calculated measurement value of the slope is smaller than the absolute value of the ideal value, the arithmetic operation unit 120 generates the second correction data that increases the mirror ratio. Thereby, the slope is corrected.

In the method for adjusting the resistance value of the variable resistance circuit 1052, a value for designating the resistance value of the variable resistance circuit 1052 is set in the fourth storage unit 1214 as the second correction data. The resistors R1s and R1p in the variable resistance circuit 1052 have the same circuit configuration as in the variable resistance circuit 107, and the resistance values thereof can be changed by turning on or off a plurality of switch elements in accordance with the value in the fourth storage unit 1214. For example, if the absolute value of the calculated measurement value of the slope is larger than the absolute value of the ideal value in an initial state (e.g., R1s=0Ω and R1p>>R2) of the variable resistance circuit 1052, the arithmetic operation unit 120 sets the second correction data that makes the combined resistance value of the external resistor R2 and the variable resistance circuit 1052 smaller than the resistance value of the external resistor R2. That is, the arithmetic operation unit 120 generates the second correction data that decreases the resistor R1p. On the other hand, if the absolute value of the calculated measurement value of the slope is smaller than the absolute value of the ideal value, the arithmetic operation unit 120 generates the second correction data that makes the combined resistance value of the external resistor R2 and the variable resistance circuit 1052 larger than the resistance value of the external resistor R2. That is, the arithmetic operation unit 120 generates the second correction data that increases the resistor R1s. Thereby, the slope is corrected.

Next, the offset correction processing will be detailed.

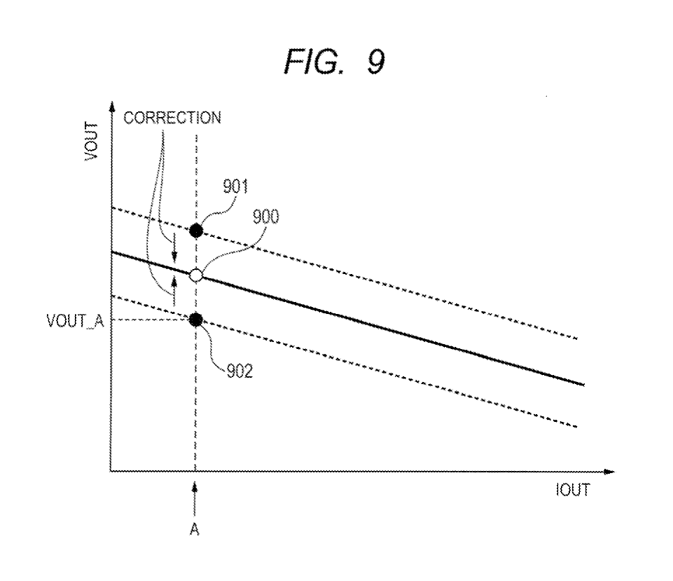

FIG. 9 is a diagram for explaining the outline of the offset correction processing. If the value of the output voltage VOUT makes a deviation (offset) from an ideal voltage 900 of the ideal characteristic 200 at a given load condition (e.g., load condition A) as shown by reference numeral 901 or 902 in FIG. 9, the offset correction processing performs correction so that the offset becomes zero. More specifically, the offset correction processing calculates the amount of deviation between the measurement data of the output voltage VOUT and the ideal value at the given load condition and corrects the reference voltage VREF inputted to the error amplifier 101 so that the amount of deviation becomes small.

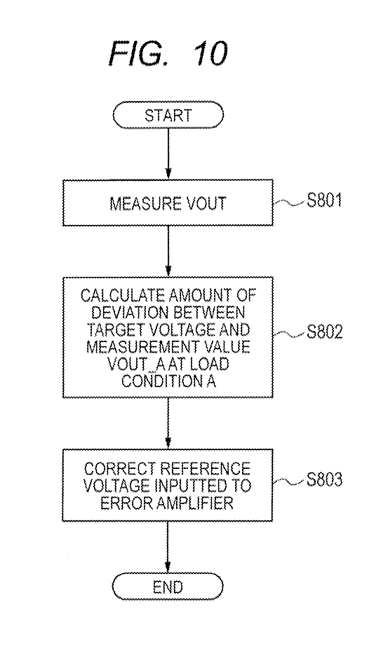

FIG. 10 is a flowchart illustrating the flow of the offset correction processing.

First, the arithmetic operation unit 120 measures the output voltage VOUT in the condition in which the output current IOUT is stable (S801). The condition in which the output current IOUT is stable refers to the condition in which the CPU core unit 20 is not executing the full-fledged program processing as in step 701 in FIG. 6.

In step 801, specifically the arithmetic operation unit 120 turns off the switch circuit SW1 coupled to the signal line to which the output voltage VOUT is supplied, and stores in the first storage unit 1211 the sense voltage VOUT_SEN of the differential amplifier DIFF_AMP of this time. For example, the arithmetic operation unit 120 stores in the first storage unit 1211 the measurement data of an output voltage VOUT_A at the load condition A in FIG. 9.

Then, the arithmetic operation unit 120 calculates the amount of deviation between the measurement value VOUT_A and the ideal value of the output voltage VOUT at the load condition A in the ideal load line characteristic, and calculates the correction data of the offset according to the amount of deviation (S802). The calculated correction data is stored in the third storage unit 1213 as the first correction data. Then, the reference voltage VREF inputted to the error amplifier 101 are changed based on the first correction data stored in the third storage unit 1213, thereby correcting the offset (S803).

Hereinafter, two methods are representatively illustrated as methods for adjusting the reference voltage VREF based on the first correction data.

FIG. 11 is an explanatory diagram illustrating a method for adjusting the reference voltage VREF as offset correction.

First, after power is applied to the VR controller 10, the digital/analog converter 102 receives and converts the initial VID data stored in the second storage unit 1212 into an analog signal as the reference voltage VREF. In the subsequent offset correction processing, for example if the measurement value VOUT_A of the output voltage is larger than the ideal value of the output voltage, the arithmetic operation unit 120 calculates new VID data that makes the output voltage VOUT lower than the target voltage based on the initial VID data set in the second storage unit 1212, and stores the calculated VID data in the third storage unit 1213 as the first correction data. On the other hand, if the measurement value VOUT_A of the output voltage is smaller than the ideal value of the output voltage, the arithmetic operation unit 120 calculates new VID data (digital value) that makes the output voltage VOUT higher than the target voltage based on the initial VID data set in the second storage unit 1212, and stores the calculated VID data in the third storage unit 1213 as the first correction data. Then, when the first correction data is stored in the third storage unit 1213 in the offset correction processing, the digital/analog converter 102 receives the first correction data stored in the third storage unit 1213 instead of the initial VID data, and converts the data into an analog signal as the corrected reference voltage VREF. Thereby, correction is performed so that the offset of the load line characteristic becomes zero.

FIG. 12 is an explanatory diagram illustrating another method for adjusting the reference voltage VREF as offset correction. As illustrated in FIG. 12, the reference voltage generation unit 108 includes a reference voltage correction unit 109 in addition to the digital/analog converter 102.

The digital/analog converter 102 converts the initial VID data set in the second storage unit 1212 into an analog signal, and outputs the analog signal. The reference voltage correction unit 109 corrects the analog signal outputted from the digital/analog converter 102 in accordance with the first correction data set in the third storage unit 1213, and outputs the corrected signal. A set initial value of the first correction data is a value (e.g., zero) that does not cause the analog signal outputted from the digital/analog converter 102 to be corrected.

In the offset correction processing, for example if the measurement value VOUT_A of the output voltage is larger than the ideal value, the arithmetic operation unit 120 calculates offset correction data that makes the output voltage VOUT lower than the target voltage based on the initial VID data, and stores the calculated data in the third storage unit 1213 as the first correction data. On the other hand, if the measurement value VOUT_A of the output voltage is smaller than the ideal value of the output voltage, the arithmetic operation unit 120 calculates offset correction data that makes the output voltage VOUT higher than the target voltage based on the initial VID data, and stores the calculated data in the third storage unit 1213 as the first correction data. The reference voltage correction unit 109 corrects the analog signal outputted from the digital/analog converter 102 in accordance with the offset correction data set in the third storage unit 1213, and inputs the corrected analog signal to the error amplifier 101 as the corrected reference voltage. Thereby, correction is performed so that the offset of the load line characteristic becomes zero.

The slope correction processing and the offset correction processing are performed, for example, as part of the starting sequence of the data processing system 100.

FIG. 13 is a flowchart showing an example of the starting sequence of the data processing system 100.

First, for example, when the power supply voltage VDD33 is applied to the VR controller 10 and the power supply voltage VDD11 is applied to the data processor 2 in the state where the input voltage VIN is applied to the voltage converter circuits 11_1 to 11_{—}n, the starting sequence of the data processing system 100 is started. In the starting sequence, first the start-up processing of the output voltage VOUT is started (S40). Then, upon the start-up of the output voltage VOUT, the correction processing is started (S41). In the correction processing, for example, first the slope correction processing is performed (S42). Then, the offset correction processing is performed (S43). Although processing sequence in the correction processing is not particularly restricted, since the magnitude of the offset may vary slightly by performing the slope correction, the offset correction processing is performed after the slope correction processing as described above, thereby making it possible to improve the accuracy of correcting the load line characteristic.

FIG. 14 is a timing chart illustrating various signals in the starting sequence of the data processing system 100.

As shown in FIG. 14, for example at time 500, the power supply voltage VDD11 and the power supply voltage VDD33 are applied. After a lapse of a predetermined time, the peripheral circuit 21 in the data processor 2 transmits control data including VID data. At time 501, the arithmetic operation unit 120 in the VR controller 10 receives the control data through the terminal CPU_S, sets the VID data included in the control data in the second storage unit 1212, and starts the start-up processing of the output voltage VOUT. In the start-up processing, the digital/analog converter 102 generates the reference voltage inputted to the error amplifier 101 based on the initial VID data set in the second storage unit 1212, and the error amplifier 101 controls the voltage converter circuits 11_1 to 11_{—}n based on the reference voltage and the feedback voltage VFB of the output voltage VOUT of the voltage regulator 1. Thereby, the output voltage VOUT of the voltage regulator 1 is controlled so that the output voltage VOUT becomes the target voltage based on the initial VID data.

Then, when the arithmetic operation unit 120 confirms that the output voltage VOUT has reached the target voltage based on the initial VID data, the arithmetic operation unit 120 outputs a notification signal Settle indicating that the output voltage VOUT has reached the target voltage, through the terminal Alert. FIG. 14 shows an example in which the arithmetic operation unit 120 switches the voltage of the terminal Alert to a low level, thereby outputting the notification signal Settle.

Upon receipt of the notification signal Settle, the peripheral circuit 21 in the data processor 2 outputs a response signal thereto to the terminal CPU_S of the VR controller 10, and also makes a notification to the CPU core unit 20. In response to the notification from the peripheral circuit 21, the CPU core unit 20 starts necessary preparation processing for starting the full-fledged program processing. The preparation processing is performed, for example, during a time period indicated by reference numeral 503, and takes e.g. a few seconds. During the time period of the preparation processing, a consumption current is smaller than in a condition in which for example the CPU core is executing the full-fledged program processing, and the consumption current (load condition) is relatively stable. The VR controller 10 performs the correction processing of the load line characteristic in the time period. More specifically, the time when the VR controller 10 starts the correction processing can be any time within the time period of reference numeral 503 after the output voltage VOUT reaches the target voltage. For example, upon receiving as a trigger the response signal to the notification signal Settle transmitted to the data processor 2 as shown at time 502, the arithmetic operation unit 120 starts the correction processing. The correction processing completes, for example, within a few milliseconds to several tens of milliseconds, and the details of the processing are described above.

Then, after the CPU core unit 20 completes the preparation processing at time 504, the peripheral circuit 21 in the data processor 2 again transmits control data including VID data. The arithmetic operation unit 120 in the VP controller 10 sets the VID data in the second storage unit 1212 again as initial VID data, and outputs the notification signal Settle when the output voltage VOUT has reached a target voltage according to the set value. In response to the notification signal Settle, the CPU core unit 20 starts the full-fledged program processing.

As described above, according to the voltage regulator 1 of the first embodiment, even if the load line characteristic of the voltage regulator 1 deviates from the ideal characteristic due to variation of circuit elements etc. configuring the VR controller 10, the VR controller 10 corrects the load line characteristic; therefore, it is possible to reduce variation in load line characteristic between voltage regulators. Further, since the VR controller 10 itself has the function of correcting the load line characteristic, it is possible to provide the voltage regulator having little variation even without measuring the load line characteristic separately by a tester or the like and trimming internal circuit elements in the production stage of the VP controller 10.

### Second Embodiment

FIG. 15 is a block diagram illustrating a data processing system according to the second embodiment. In the data processing system 300 shown in FIG. 15, the same components as those of the data processing system 100 according to the first embodiment are denoted by the same reference numerals, and detailed description thereof is omitted.

A voltage regulator 3 configuring a part of the data processing system 300 shown in FIG. 15 has a function of measuring the output current IOUT with a smaller loss in addition to the functions of the voltage regulator 1.

The voltage regulator 3 further includes a resistor RSEN inserted in series with a signal path for supplying the input voltage VIN to the voltage converter circuit 11. A VR controller 30 further includes a terminal ISP and a terminal ISN as external terminals. The terminal ISP is coupled to one end of the resistor RSEN to which the input voltage VIN is supplied, and the terminal ISN is coupled to the other end of the resistor RSEN which is coupled to the voltage converter circuit 11. The resistor RSEN may be implemented, for example, by a resistance element or by the on resistance of a transistor (e.g., MOS transistor). A current sensing unit 303 in the VR controller 30 senses an input-side current IIN of the voltage converter circuit 11 based on a voltage across the resistor RSEN inputted through the terminal ISP and the terminal ISN. Then, the current sensing unit 303 calculates the output current IOUT based on the sensed input-side current IIN, and outputs information (sense current information) indicating the magnitude of the calculated output current IOUT. The sense current information outputted from the current sensing unit 303 is outputted e.g. as a voltage as in the current sensing unit 103.

Letting PLOSS be a power loss in the voltage regulator 3, PIN be an input power, and POUT be an output power, the relationship between PIN and POUT is expressed by the following equation (2).

PIN=POUT+PLOSS (2)

Further, PIN and POUT are expressed by the following equation (3). Furthermore, letting Vrsen be the voltage across the resistor RSEN, the current IIN is expressed by the following equation (4).

$$\begin{matrix}PIN = VIN \times IIN , POUT = VOUT \times IOUT & ( 3 ) \\ IIN = \frac{Vrsen}{RSEN} & ( 4 )\end{matrix}$$

Therefore, based on the equations (2) to (4), the output current IOUT is expressed by the following equation (5).

$$IOUT = \frac{( \frac{VIN \cdot Vrsen}{RSEN} - PLOSS )}{VOUT} \qquad ( 5 )$$

Thus, the current sensing unit 303 measures the voltage Vrsen across the resistor RSEN and performs an arithmetic operation in accordance with equation (5), thereby calculating the magnitude of the output current IOUT. According to this, since the input-side current IIN is smaller than the output current IOUT of the voltage converter circuit 11, it is possible to measure the output current IOUT with a smaller loss, for example compared to a method for measuring the output current IOUT by inserting a current sensing resistor into the signal path to which the output voltage VOUT is supplied, and therefore suppress a decrease in the efficiency of the voltage regulator 3 associated with the sensing of the output current IOUT. In the arithmetic operation by the current sensing unit 303, the output value of the differential amplifier DIFF_AMP can be used as the value of the output voltage VOUT, and e.g. data stored beforehand in a nonvolatile storage area or the like can be used as the value of the resistor RSEN and the value of the power loss PLOSS.

Further, the VR controller 30 according to this embodiment can perform dynamic slope correction in the condition in which the CPU core unit 20 as the load on the voltage regulator 3 is executing the full-fledged program processing (the output current IOUT is unstable).

FIG. 16 is a diagram for explaining the outline of the dynamic slope correction processing by the VR controller 30. As shown in FIG. 16, the output current IOUT and the output voltage VOUT are measured p times (p is an integer not less than 2) in the condition in which the CPU core unit 20 is executing the full-fledged program processing. An arithmetic operation unit 320 calculates the slope of the load line characteristic based on p pieces of measurement data (data items 50_1 to 50_{—}p comprised of pairs of the output voltage VOUT measurement values and the corresponding output current IOUT measurement values, calculates the amount of deviation from the ideal value of the slope, and generates second correction data that decreases the deviation. A method for correcting the slope based on the second correction data is the same as in the first embodiment.

Although not restricted, the dynamic slope correction processing is executed at predetermined time intervals. For example, when the count value of a counter provided in the VR controller 30 matches a predetermined value, the arithmetic operation unit 320 executes the slope correction processing. Alternatively, it is also possible to start the slope correction processing in response to the control signal transmitted from the data processor 2 to the VR controller 30.

As described above, according to the voltage regulator 3 of the second embodiment, with the other configuration being the same as that of the voltage regulator 1, it is possible to reduce variation in load line characteristic. Further, according to the voltage regulator 3, it is possible to measure the output current IOUT with a smaller loss and therefore suppress a decrease in the efficiency of the voltage regulator 3 associated with the sensing of the output current IOUT. Further, the voltage regulator 3 can perform the dynamic slope correction processing, and accordingly correct the slope of the load line characteristic even at an inconstant load condition.

While the invention made above by the present inventors has been described specifically based on the illustrated embodiments, the present invention is not limited thereto. It is needless to say that various changes and modifications can be made thereto without departing from the spirit and scope of the invention.

For example, while there is shown an example in which the data processing systems 100, 300 are a personal computer, the data processing systems 100, 300 may be any other electronic device utilizing program control.

While there is shown an example in which the resistor Rdroop is an external resistor in the resistance circuit 106, the resistor Rdroop may be a resistor formed within the VR controller 10. Similarly, the resistor R2 in the current source circuit 1051 may be a resistor formed within the VP controller 10.

The methods for correcting the load line characteristic using the first correction data and the second correction data are not limited to the methods shown in FIGS. 7, 8, 11, and 12, and can be changed in accordance with the circuit configuration in the VR controller 10.

While FIG. 13 shows an example in which the offset correction processing is performed after the slope correction processing, the slope correction processing may be performed after the offset correction processing if the amount of offset change before and after the slope correction is negligible.

While there is shown an example in which the correction processing of the load line characteristic is performed as part of the starting sequence of the data processing systems 100, 300, the correction processing may be performed with any other timing. For example, the correction processing may be performed with timing before and after the data processor 2 transitions to a sleep state or a standby state, or with timing before and after the data processor 2 transitions from the sleep state or the standby state to an normal operation state, or can be performed with timing of updating the VID data.

What is claimed is:

1. A voltage regulator which supplies a power supply voltage to a coupled load and varies the power supply voltage in accordance with a load current of the load, the voltage regulator comprising:
a voltage converter circuit for generating and outputting the power supply voltage based on an input voltage; and
a control unit for controlling the voltage converter circuit,
wherein the control unit comprises:
an output voltage adjustment unit which controls the voltage converter circuit so that an output voltage of the voltage converter circuit becomes a target voltage when the voltage regulator is in a no-load condition, and controls the voltage converter circuit so as to have a transition characteristic in which the output voltage decreases with increase in the load current; and
a correction unit which performs first correction processing for calculating the amount of deviation between a measurement value of the output voltage and an ideal value thereof when a load condition of the voltage regulator is a first load condition and correcting the target voltage by the output voltage adjustment unit so that the deviation becomes small, and performs second correction processing for calculating the amount of deviation between a measurement value of a rate of change of the output voltage with respect to the load current and an ideal value thereof and correcting the transition characteristic so that the deviation becomes small.

2. The voltage regulator according to claim 1,
wherein the correction unit comprises:
an arithmetic operation unit;
a first storage unit for storing first correction data for correcting the target voltage; and
a second storage unit for storing second correction data for correcting the transition characteristic,
wherein in the first correction processing, the arithmetic operation unit calculates the amount of deviation between the measurement value of the output voltage and the ideal value at the first load condition, generates the first correction data according to the amount of deviation, and stores the first correction data in the first storage unit, and in the second correction processing, the arithmetic operation unit calculates the amount of deviation between the measurement value of the rate of change of the output voltage with respect to the load current and the ideal value, generates the second correction data according to the amount of deviation, and stores the second correction data in the second storage unit, and
wherein the output voltage adjustment unit adjusts a control amount of the voltage converter circuit based on values set in the first storage unit and the second storage unit.

3. The voltage regulator according to claim 2, wherein in the second correction processing, the arithmetic operation unit calculates the measurement value of the rate of change, based on the measurement value of the output voltage at the first load condition, a measurement value of the output voltage at a second load condition whose load current is larger than that of the first load condition, and the amount of increase of the load current after a transition from the first load condition to the second load condition.

4. The voltage regulator according to claim 3, further comprising a first resistor which can be coupled between a node to which the output voltage is supplied and a ground node to which a ground voltage is supplied,
wherein in the second correction processing, the arithmetic operation unit couples the first resistor to effect the transition from the first load condition to the second load condition, and calculates the amount of increase of the load current based on the measurement value of the output voltage after the transition and a resistance value of the first resistor.

5. The voltage regulator according to claim 2, wherein the arithmetic operation unit starts the first correction processing and the second correction processing in response to a predetermined notification signal transmitted from the load.

6. The voltage regulator according to claim 2,
wherein the output voltage adjustment unit comprises:
an error amplifier;
a current sensing unit for sensing the load current;
a current generation unit for generating a first current according to the load current sensed by the current sensing unit; and
a first resistance circuit for converting the first current into a voltage and generating a feedback voltage obtained by adding the converted voltage to a voltage according to the output voltage of the voltage converter circuit, and
wherein the error amplifier receives a reference voltage based on the target voltage and the feedback voltage, generates a control signal so that an error between two input voltages becomes small, and provides the control signal to the voltage converter circuit.

7. The voltage regulator according to claim 6, wherein a resistance value of the first resistance circuit is determined based on the second correction data stored in the second storage unit.

8. The voltage regulator according to claim 6,
wherein the current sensing unit outputs a voltage according to the sensed load current,
wherein the current generation unit comprises;
a current source circuit for generating a second current based on a voltage according to the load current outputted from the current sensing unit; and
a current mirror unit for outputting the first current by mirroring the second current at a predetermined mirror ratio, and
wherein the current source circuit comprises a second resistance circuit for determining a current value of the second current.

9. The voltage regulator according to claim 8, wherein a resistance value of the second resistance circuit is determined based on the second correction data stored in the second storage unit.

10. The voltage regulator according to claim 6,
wherein the output voltage adjustment unit further comprises a digital/analog converter for converting an inputted digital signal into an analog signal and outputting the converted analog signal as the reference voltage,
wherein the arithmetic operation unit corrects a digital value designating the inputted target voltage based on the amount of deviation calculated in the first correction processing, and stores the corrected digital value in the first storage unit as the first correction data, and
wherein the digital/analog converter receives the first correction data stored in the first storage unit.

11. The voltage regulator according to claim 2, wherein the arithmetic operation unit performs the first correction processing after performing the second correction processing.

12. The voltage regulator according to claim 6, further comprising a second resistor inserted in series with a signal path for supplying the input voltage to the voltage converter circuit,
wherein the current sensing unit measures the load current based on a voltage across the second resistor.

13. A semiconductor device which generates a control signal for controlling a switch circuit included in a switching regulator, the semiconductor device comprising:
an output voltage adjustment unit which generates the control signal so that an output voltage of the switching regulator becomes a target voltage when the switching regulator is in a no-load condition, and generates the control signal so as to have a transition characteristic in which the output voltage decreases with increase in a load current of a load coupled to the switching regulator; and
a correction unit which performs first correction processing for calculating the amount of deviation between a measurement value of the output voltage and an ideal value thereof when a load condition of the switching regulator is a first load condition and correcting the target voltage so that the deviation becomes small, and performs second correction processing for calculating the amount of deviation between a measurement value of a rate of change of the output voltage with respect to the load current and an ideal value thereof and correcting the transition characteristic so that the deviation becomes small.

14. The semiconductor device according to claim 13,
wherein the correction unit comprises:
an arithmetic operation unit;
a first storage unit for storing first correction data for correcting the target voltage; and
a second storage unit for storing second correction data for correcting the transition characteristic, and
wherein in the first correction processing, the arithmetic operation unit calculates the amount of deviation between the measurement value of the output voltage and the ideal value at the first load condition, generates the first correction data according to the amount of deviation, and stores the first correction data in the first storage unit, and in the second correction processing, the arithmetic operation unit calculates the amount of deviation between the measurement value of the rate of change of the output voltage with respect to the load current and the ideal value, generates the second correction data according to the amount of deviation, and stores the second correction data in the second storage unit.

15. The semiconductor device according to claim 14, further comprising a first terminal for outputting a signal,
wherein the arithmetic operation unit outputs to the first terminal a signal that causes the load condition of the switching regulator to transition between the first load condition and a second load condition.

16. A data processing system comprising:
a data processor; and
a voltage regulator for generating a power supply voltage supplied to the data processor,
wherein the voltage regulator comprises:
a voltage converter circuit for generating and outputting the power supply voltage based on an input voltage; and
a control unit for controlling the voltage converter circuit, and
wherein the control unit comprises:
an output voltage adjustment unit which controls the voltage converter circuit so that an output voltage of the voltage converter circuit becomes a target voltage when the data processor is in a first operating condition, and controls the voltage converter circuit so as to have a transition characteristic in which the output voltage decreases with increase in a consumption current when the data processor is in an operating condition whose consumption current is larger than that of the first operating condition; and
a correction unit which performs first correction processing for calculating the amount of deviation between a measurement value of the output voltage and an ideal value thereof at the first operating condition and correcting the target voltage by the output voltage adjustment unit so that the deviation becomes small, and performs second correction processing for calculating the amount of deviation between a measurement value of a rate of change of the output voltage with respect to the consumption current and an ideal value thereof and correcting the transition characteristic so that the deviation becomes small.

17. The data processing system according to claim 16,
wherein the correction unit comprises:
an arithmetic operation unit;
a first storage unit for storing first correction data for correcting the target voltage; and
a second storage unit for storing second correction data for correcting the transition characteristic,
wherein in the first correction processing, the arithmetic operation unit calculates the amount of deviation between the measurement value of the output voltage and the ideal value at the first operating condition, generates the first correction data according to the amount of deviation, and stores the first correction data in the first storage unit, and in the second correction processing, the arithmetic operation unit calculates the amount of deviation between the measurement value of the rate of change of the output voltage with respect to the consumption current and the ideal value, generates the second correction data according to the amount of deviation, and stores the second correction data in the second storage unit, and
wherein the output voltage adjustment unit adjusts a control amount of the voltage converter circuit based on values set in the first storage unit and the second storage unit.

18. The data processing system according to claim 17,
wherein the data processor comprises a CPU core unit which operates by being supplied with the output voltage and a communication unit which operates by being supplied with a power supply voltage different from the output voltage and can communicate with the control unit,
wherein the communication unit transmits first data designating a set value of the output voltage, and
wherein the output voltage adjustment unit determines the target voltage based on the received first data and controls the voltage converter circuit.

19. The data processing system according to claim 18, wherein the arithmetic operation unit performs the first correction processing and the second correction processing during a time period when a consumption current of the CPU core unit is stable.

20. The data processing system according to claim 18, wherein the arithmetic operation unit starts the first correction processing and the second correction processing when the output voltage has reached the target voltage after receiving the first data transmitted first after power is applied to the control unit.
